(19) United States
(12) Patent Application Publication
(10) Pub. No.: US 2025/0076961 A1
(43) Pub. Date: Mar. 6, 2025

(54) DYNAMIC PERFORMANCE SWITCHING PROCESSOR AND METHOD THEREOF

(71) Applicant: INTELLIGO TECHNOLOGY INC., Zhubei City (TW)

(72) Inventors: Zheng-Xian WU, Zhubei City (TW); Yu-Cheng ZHANG, Zhubei City (TW); Shun-Che HSU, Zhubei City (TW); Tsung-Liang CHEN, Zhubei City (TW)

(21) Appl. No.: 18/519,252

(22) Filed: Nov. 27, 2023

(30) Foreign Application Priority Data
Aug. 30, 2023 (TW) 112132710

(51) Int. Cl. G06F 1/324

(52) U.S. Cl. CPC G06F 1/324

(57) ABSTRACT

A processor comprises an execution unit and a performance switching module coupled to the execution unit. The performance switching module includes a control unit, a clock control unit, a voltage control unit and a multi-cycle path control unit. The control unit is configured to output at least one control instruction according to a performance requirement of the processor. The clock control unit is configured to receive a clock adjustment instruction on the at least one control instruction to adjust a clock rate provided to the execution unit. The voltage control unit is configured to receive a voltage adjustment instruction of the at least one control instruction to adjust a supplied voltage provided to the execution unit. The multi-cycle path control unit is configured to receive a path adjustment instruction of the at least one control instruction to adjust a cycle number of the instruction execution cycle of the execution unit.

### FIELD OF THE INVENTION

The disclosure relates to a processor and a method; in particular to a processor able to dynamically switch performance and a method for dynamically switching the performance of the processor.

### BACKGROUND OF THE INVENTION

When designing a processor, there is always a dilemma between high-performance and low-power consumption. More specifically, processors with high-performance will have a higher processing frequency or more stages in a pipeline architecture. However, when accessing a simple task which is low requirement of performance, the processors with high-performance will waste the power or resources. On the contrary, processors with low-power consumption typically operate at a lower processing frequency and are configured by an architecture with few stages of pipeline. Accordingly, the processors with low-power consumption are not able to operate in high processing frequency and use for complex tasks.

The conventional architecture for processor to enable processors to have both benefits of efficient and low-power consumption is heterogeneous computing architecture, such as the big.LITTLE architecture proposed by ARM. However, the heterogeneous computing architecture has hardware components for relatively battery-saving and slower processor cores and hardware components for relatively more powerful and power-hungry processor. In other words, the hardware cost of heterogeneous computing architectures will be twice or even more than general processors with equivalent performance or power consumption.

Therefore, there are unmet needs for improvement in the hardware architecture of the processor.

### SUMMARY OF THE INVENTION

One of the purposes of the presented invention is to provide an architecture for a processor that enables both efficient and low-power applications.

One of the purposes of the presented invention is to save the cost of conventional heterogeneous computing architectures, such as cost for manufacturing, maintenance, stocking, or warehousing.

The disclosure provides a processor. The processor comprises an execution unit and a performance switching module coupled to the execution unit. The performance switching module includes a control unit, a clock control unit, a voltage control unit and a multi-cycle path control unit. The control unit is configured to output at least one control instruction according to a performance requirement of the processor. The clock control unit is configured to receive a clock adjustment instruction on the at least one control instruction to adjust a clock rate provided to the execution unit. The voltage control unit is configured to receive a voltage adjustment instruction of the at least one control instruction to adjust a supplied voltage provided to the execution unit. The multi-cycle path control unit is configured to receive a path adjustment instruction of the at least one control instruction to adjust a cycle number of the instruction execution cycle of the execution unit.

The disclosure provides a dynamic performance switching method for a processor. The method comprises: arranging a performance switching module to couple with an execution unit of the processor; adjusting, by the performance switching module, a cycle number of an instruction execution cycle of the execution unit according to a performance requirement of the processor; and adjusting, by the performance switching module, a clock rate or a supplied voltage provided to the execution unit according to the performance requirement.

As mentioned above, the proposed processor of the presented invention adjusts, by the performance switching module, various parameters in the execution unit of the processor. The performance switching module may dynamically switch performance based on the performance requirements required by the processor. The performance switching module will make the processor suitable for high-performance and low-power applications. The presented processor can, for example, improve the hardware costs required for the heterogeneous computing architectures. More specifically, to produce the processor, the designer only needs to maintain, design, or manufacture the execution unit with single model/specification. Therefore, the cost for producing the processor is decreased. In addition, the cost for hardware stocking or warehousing can also be correspondingly reduced.

### BRIEF DESCRIPTION OF THE DRAWINGS

The accompanying drawings are presented to aid in the description of various aspects of the disclosure and are provided solely for illustration of the aspects. In order to simplify the drawings and highlight the contents to be presented in the drawings, the well-known structures or elements in the drawings may be drawn in a simple schematic manner or presented in an omitted manner. For example, the number of elements may be singular or plural. These drawings are provided only to explain these aspects and not to limit thereof.

FIG. 1 is a block diagram of the architecture of the processor according to the first embodiment of the presented invention.

FIGS. 2 and 3 are schematic diagrams of the instruction processing sequence in the first embodiment of the present invention.

FIG. 4 is a flowchart of the method for dynamically switching performance of the processor according to the second embodiment of the presented invention.

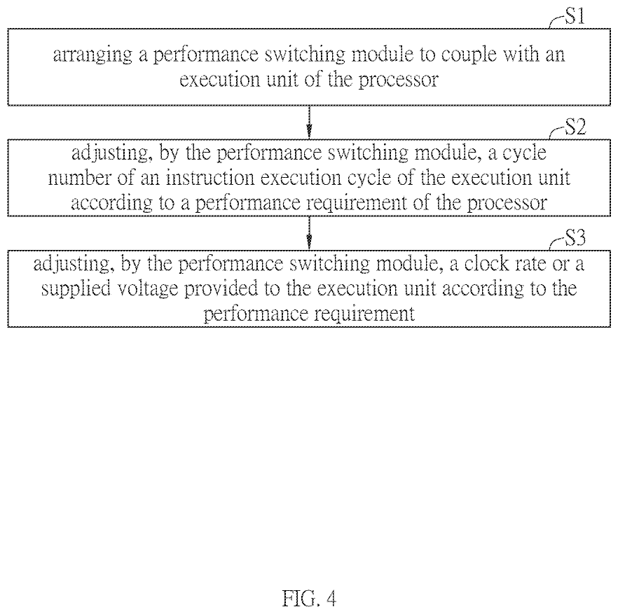

### DETAILED DESCRIPTION OF THE PREFERRED EMBODIMENTS

Even though the terms such as “first”, “second”, and “third” may be used to describe an element, a part, a region, a layer, and/or a portion in the present specification, these elements, parts, regions, layers and/or portions are not limited by such terms. Such terms are used to differentiate an element, a part, a region, a layer, and/or a portion from another element, part, region, layer, and/or portion. Therefore, in the following discussions, a first element, portion, region, or portion may be called a second element, portion, region, layer, or portion, and do not depart from the teaching of the present disclosure. The terms “comprise,” “include”, or “have” used in the present specification are open-ended terms and mean to “include”, but not limit to

As used herein, the term “coupled to” in the various tenses of the verb “couple” may mean that element A is directly connected to element B or that other elements may be connected between elements A and B (i.e., that element A is indirectly connected with element B).

The terms “approximate” or “essentially” used in the present specification include the value itself and the average values within the acceptable range of deviation of the specific values confirmed by a person having ordinary skill in the current art, considering the specific measurement discussed and the number of errors related to such measurement (that is, the limitation of the measurement system). For example, “about” may mean within one or more standard deviations of the value itself or ±30%, ±20%, ±10%, ±5%. In addition, “about”, “approximate”, or “essentially” used in the present specification may select a more acceptable range of deviation or standard deviation based on optical property, etching property, or other properties. One cannot apply one standard deviation to all properties.

### First Embodiment

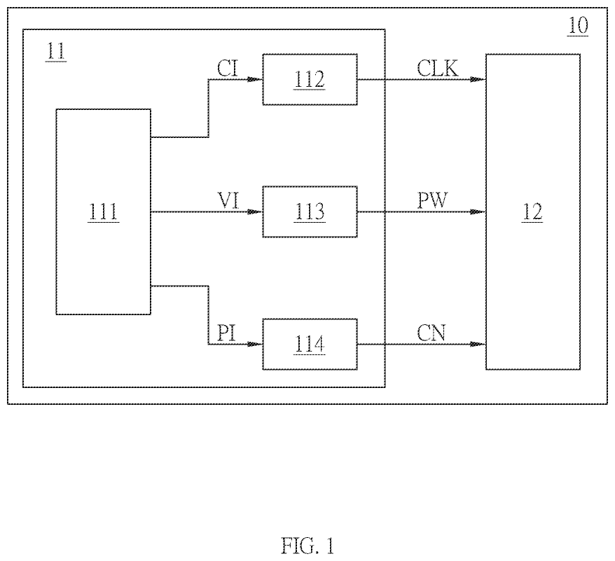

Refer to FIG. 1, FIG. 1 illustrates the processor 10 comprising the execution unit 12 and the performance switching module 11 coupled to the execution unit 12. The performance switching module 11 includes the control unit 111, the clock control unit 112, the voltage control unit 113 and the multi-cycle path control unit 114. The control unit 111 is configured to output the at least one control instruction (CI, VI, PI) according to the performance requirement of the processor 10. The clock control unit 112 is configured to receive clock adjustment instruction (CI) of the at least one control instruction to adjust the clock rate (CLK) provided to the execution unit 12. The voltage control unit 113 is configured to receive the voltage adjustment instruction (VI) of the at least one control instruction to adjust the supplied voltage (PW) provided to the execution unit 12. The multi-cycle path control unit 114 is configured to receive the path adjustment instruction (PI) of the at least one control instruction to adjust the cycle number (CN) of the instruction execution cycle of the execution unit 12.

More specifically, the processor 10 may be applied to any device with high efficiency or low power consumption requirements, such as a mobile phone or wearable device. When the processor 10 is a multi-core processor, it may have at least one performance switching module 11 which is configured to perform performance switching on the multiple cores (execution unit 12) of the processor 10. The execution unit 12 can be a microprocessor (MCU), floating-point arithmetic unit (FPU), or other unit, means or component that performs instruction execution/operation.

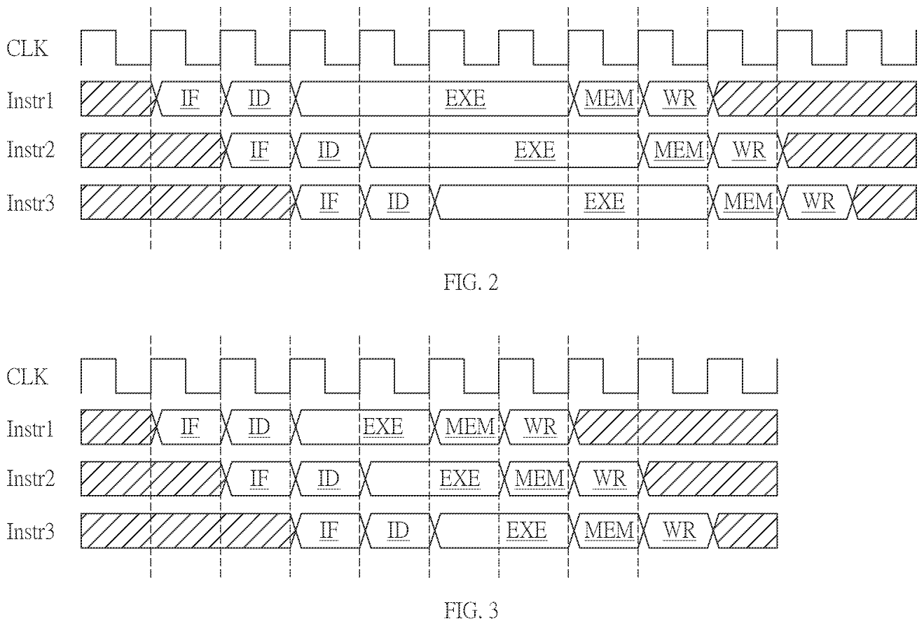

In an application example, when the performance requirement of the processor 10 is set to a high-performance mode, the control unit 111 of the performance switching module 11 receives the commands/orders for setting to high performance. The Control unit 111 will issue, to the multi-cycle path control unit 114, the path adjustment instruction PI to increase the cycle number (CN) of the instruction execution cycle of the execution unit 12 to high-performance cycle number (CN_{HP}). More specifically, as shown in FIG. 2, taking the instruction processing thread of RISC as an example, executing an instruction can be divided into five stages, which are denoted as stage for instruction fetching (IF), stage for instruction decoding and register fetch (ID), stage for execution (EXE), stage for memory access (MEM), and stage for writing back (WR). Among the five stages, the multi-cycle path control unit 114 can increase the cycle number (CN) required for the stage for execution (EXE). For example, as shown in FIG. 2, the cycle number (CN) required for the stage for execution (EXE) of the execution unit 12 is increased from one cycle to four cycles. It should be noted that FIG. 2 is only an example and is not intended to limit the multi-cycle path control unit 114 of the presented invention. The multi-cycle path control unit 114 of the presented invention can regulate cycle per instruction (CPI) of the processor 10 by settings different cycle number (CN), such as one to multiple cycles, to the stage for execution (EXE) of the execution unit 12.

After cycle number (CN) of the instruction execution (EXE) of the execution unit 12 is adjusted to a cycle number with high-performance (CN_{HP}), the control unit 111 outputs the clock adjustment instruction (CI) to cause the clock control unit 112 raising the clock rate (CLK) to a high-performance clock rate (CLK_{HP}). For example, the clock control unit 112 may be the conventional clock circuits such as oscillators, frequency dividers, or frequency multipliers. The clock control unit 112 can adjust the clock rate (CLK) provided to the execution unit 12 based on the clock adjustment instruction (CI) of the control unit 111. For example, but not limited to, the clock rate (CLK) provided by the clock control unit 112 may be raised from 80 MHz to 400 MHz. In addition, the high-performance clock rate (CLK_{HP}) is, for example, corresponding to the longest cycle time required in stages of RSIC processing thread (IF, ID, EXE, MEM and WR). More specifically, in order to match the processing time of each stage in the pipeline, the clock rate (CLK) will be matched to the slowest stage. In general, the stage for execution (EXE) usually takes a long time compare to other stages. By splitting the instruction execution cycle (EXE) into multiple cycle (CN) and increasing the clock rate (CLK), the performance of the processor 10 can be effectively improved.

On the other hand, in another application example, when the performance requirement of the processor 10 is a low-power consumption and/or a long-term operation, the control unit 111 of the performance switching module 11 receives the commands/orders for low-power setting. As shown in FIG. 3, the control unit 111 will issue, to the multi-cycle path control unit 114, a path adjustment instruction (PI) to reduce the cycle number (CN) of the instruction execution cycle (EXE) to a low-power consumption cycle number (CN_{LP}). For example, as shown in FIG. 3, the cycle number (CN) of the execution unit 12 for executing instruction from four cycles to two cycles. It should be noted that the low power consumption cycle number (CN_{LP}) and high-performance cycle number (CN_{HP}) of the presented invention are a concept of relative value and does not have absolute numerical value. In addition, the performance requirements of the processor 10 can also have a moderate requirement, which can be met by setting multiple stages between low power consumption cycle number (CN_{LP}) and the high-performance cycle number (CN_{HP}) to meet various application.

When the cycle number (CN) for executing instruction (EXE) of the execution unit 12 is set to low-power consumption cycle number (CN_{LP}), the control unit 111 can output a clock adjustment instruction (CI) to cause the clock control unit 112 decreasing the clock rate (CLK) to a low-power clock rate, for example 80 MHz. Furthermore, the control unit 111 outputs a voltage adjustment instruction (VI) to cause the voltage control unit 113 decreasing the supplied voltage (PW) to a low-power consumption supplied voltage (PW_{LP}), for example from 0.9 V to 0.8 V. By reducing the cycle number (CN) for executing instructions and reducing the clock rate (CLK) and the supplied voltage (PW), the power consumption of the processor 10 can be effectively reduced. When high-performance processing operations are not required, the endurance of the processor 10 will be improved and the heat generation of the processor 10 will be reduced.

The implementation of the multi-cycle path control unit 114 can be carried out, for example, means for calculating/controlling the number of execution cycles of the execution unit 12. More specifically, the multi-cycle path control unit 114 can control the execution unit 12 to execute instruction in a specified number of cycles (such as efficient cycle number (CN_{HP}) or low-power consumption cycle number (CN_{LP})). The multi-cycle path control unit 114 will retrieve the results of the execution unit 12 operation. For example, if the current clock period of the execution unit 12 is 10 ns and the execution unit 12 takes 45 ns for processing an operation. Therefore, the execution unit 12 requires at least 5 cycles to complete this operation. In the scenario, the control unit 111 will adjust the setting of the multi-cycle path control unit 114. The multi-cycle path control unit 114 will retrieve the result of the operation after the execution unit 12 executed to the fifth cycles.

It should be noted that the performance switching module can receive performance requirements indicating that the processor is in high-performance mode or a low-power consumption mode. The performance requirements can be provided by users/operators of the processor, or provided based on operational requirements such as instruction complexity. For example, if want to set a device to a low-power consumption mode such as sleep or standby, the operator of the device can manually provide instructions indicated the low-power performance requirement or the system of the device switches to the low-power consumption mode according to the settings of the system. On the other hand, users can also manually provide instructions indicated the high-performance requirements based on the current required computational load or application complexity, or the system can automatically switch to the high-performance mode based on the computing loading of the processor.

In summary, the parameters for the processor 10 of the presented invention in high-performance mode or a low-power consumption mode are shown in the following table:

| | instruction execution | clock rate | supplied |
|---|---|---|---|
| Application | cycle (cycles) | (MHz) | voltage (V) |
| high-performance | 4 | 400 | 0.9 |
| mode | | | |
| low-power | 2 | 80 | 0.8 |
| consumption mode | | | |

It should be noted that the configurations and numbers in the table are only for simplification and are not intended to limit the presented invention. In addition, the presented invention can also be adapted to various applications, such as medium performance or medium power consumption settings. There may include at least one or more hierarchical applications between the high-performance mode and the low-power consumption mode.

Through the processor 10 of the presented invention, it is possible to switch settings when facing high-performance and low-power applications. The processor 10 may dynamically switch performance based on the performance requirements. This can make the processor 10 suitable for the high-performance and low-power applications. The processor 10 can also save the hardware costs required for the conventional heterogeneous computing architectures. Compared to the conventional heterogeneous computing architectures (such as the big. LITTLE architecture), the performance switching module 11 of the presented invention is coupled and corresponded to the execution unit 12 to apply function of switching performance a single execution unit. Therefore, the issue for switching between a high-performance execution unit and a low-power execution unit in heterogeneous computing architectures can be solved. More specifically, when a conventional processor with the heterogeneous computing architecture has to switch to low-power execution unit from the high-performance execution unit. Usually, the conventional processor is necessary to reduce the clock frequency and then switch to the low-power execution unit. On the contrary, if the conventional processor has to switch to the high-performance execution unit from the low-power execution unit, the conventional processor needs to adjust the MCP, and then adjusts the clock frequency. These adjustment settings for switching between the high-performance execution unit and the low-power execution unit usually take dozens of clock cycles to complete the switch task. In comparison, regarding to the processor 10 of the presented invention, the processor 10 does not need to switch/replace the execution unit of the processor in the conversion task for switching high performance and low power consumption. The processor 10 may directly regulate the execution unit 12, which can greatly reduce the conversion time for the conversion task for switching high performance and low power consumption.

### Second Embodiment

The presented invention provides a dynamic performance switching method for a processor. The method comprises: arranging a performance switching module to couple with an execution unit of the processor (step S1); adjusting, by the performance switching module, a cycle number of an instruction execution cycle of the execution unit according to a performance requirement of the processor (step S2); and adjusting, by the performance switching module, a clock rate or a supplied voltage provided to the execution unit according to the performance requirement (step S3).

In an embodiment, when the performance requirement of the processor is set to a high-performance mode, the control unit outputs the path adjustment instruction to cause the multi-cycle path control unit increasing the cycle number of the instruction execution cycle of the execution unit to a high-performance cycle number. Furthermore, after the cycle number of the instruction execution cycle of the execution unit is adjusted to the high-performance cycle number, the control unit outputs the clock adjustment instruction to cause the clock control unit increasing the clock rate to a high-performance clock rate.

In an embodiment, wherein when the performance requirement of the processor is set to a low-power consumption mode, the control unit outputs the path adjustment instruction to cause the multi-cycle path control unit decreasing the cycle number of the instruction execution cycle of the execution unit to a low-power consumption cycle number. Furthermore, after the cycle number of the instruction execution cycle of the execution unit is adjusted to the low-power consumption cycle number, the control unit outputs the voltage adjustment instruction to cause the voltage control unit decreasing the supplied voltage to a low-power consumption supplied voltage.

The dynamic performance switching method of the presented invention enables the processor to adjust the instruction execution cycle based on “performance requirements”. For example, when a processor executes instructions or instruction sets such as floating-point operations, the processor will adjust the instruction execution cycle and/or corresponding clock rate or supplied voltage according to the performance requirement. In other words, the cycles per instruction (CPI) of the processor will be adjusted according to the “performance requirements” during the processor processing instructions. Although executing same instructions or instruction set, the processor of the presented invention can have different settings for the instruction execution cycles and/or the corresponding clock rate or supplied voltage to operate in different performance to handle the instructions. Moreover, the performance requirements can be provided by the user/operator of the processor, or can be provided based on operational requirements such as instruction complexity. For example, if want to set a device to a low-power consumption mode such as sleep or standby, the operator of the device can manually provide instructions indicated the low-power performance requirement or the system of the device switches to the low-power consumption mode according to the settings of the system. On the other hand, users can also manually provide instructions indicated the high-performance requirements based on the current required computational load or application complexity, or the system can automatically switch to the high-performance mode based on the computing loading of the processor.

Through the dynamic performance switching method of the presented invention, the processor can switch settings when facing high-efficiency and low-power applications to dynamically switch performance based on the performance requirements required by the processor. The method makes the processor suitable for both of high-performance and low-power applications. To produce the processor, apply the method of the presented invention, the designer only needs to maintain, design, or manufacture the execution unit with single model/specification. Therefore, the cost for producing the processor is decreased. In addition, the cost for hardware stocking or warehousing can also be correspondingly reduced.

The foregoing disclosure is merely preferred embodiments of the present invention and is not intended to limit the claims of the present invention. Any equivalent technical variation of the description and drawings of the present invention of the present shall be within the scope of the claims of the present invention.

What is claimed is:

1. A processor comprising:
an execution unit; and
a performance switching module coupled to the execution unit, the performance switching module including:
a control unit configured to output at least one control instruction according to a performance requirement of the processor;
a clock control unit coupled to the control unit; wherein the clock control unit is configured to receive a clock adjustment instruction on the at least one control instruction to adjust a clock rate provided to the execution unit;
a voltage control unit coupled to the control unit; wherein the voltage control unit is configured to receive a voltage adjustment instruction of the at least one control instruction to adjust a supplied voltage provided to the execution unit; and
a multi-cycle path control unit coupled to the control unit; wherein the multi-cycle path control unit is configured to receive a path adjustment instruction of the at least one control instruction to adjust a cycle number of the instruction execution cycle of the execution unit.

2. The processor of claim 1, wherein when the performance requirement is set to a high-performance mode, the control unit outputs the path adjustment instruction to cause the multi-cycle path control unit increasing the cycle number of the instruction execution cycle of the execution unit to a high-performance cycle number.

3. The processor of claim 2, wherein after the cycle number of the instruction execution cycle of the execution unit is adjusted to the high-performance cycle number, the control unit outputs the clock adjustment instruction to cause the clock control unit increasing the clock rate to a high-performance clock rate.

4. The processor of claim 1, wherein when the performance requirement is set to a low-power consumption mode, the control unit outputs the path adjustment instruction to cause the multi-cycle path control unit decreasing the cycle number of the instruction execution cycle of the execution unit to a low-power consumption cycle number.

5. The processor of claim 4, wherein when the cycle number of the instruction execution cycle of the execution unit is adjusted to the low-power consumption cycle number, the control unit outputs the voltage adjustment instruction to cause the voltage control unit decreasing the supplied voltage to a low-power consumption supplied voltage.

6. A dynamic performance switching method for a processor, comprising:
arranging a performance switching module to couple with an execution unit of the processor;
adjusting, by the performance switching module, a cycle number of an instruction execution cycle of the execution unit according to a performance requirement of the processor; and
adjusting, by the performance switching module, a clock rate or a supplied voltage provided to the execution unit according to the performance requirement.

7. The method of claim 6, wherein when the performance requirement is set to a high-performance mode, the control unit outputs the path adjustment instruction to cause the multi-cycle path control unit increasing the cycle number of the instruction execution cycle of the execution unit to a high-performance cycle number.

8. The method of claim 7, wherein after the cycle number of the instruction execution cycle of the execution unit is adjusted to the high-performance cycle number, the control unit outputs the clock adjustment instruction to cause the clock control unit increasing the clock rate to a high-performance clock rate.

9. The method of claim 6, wherein when the performance requirement is set to a low-power consumption mode, the control unit outputs the path adjustment instruction to cause the multi-cycle path control unit decreasing the cycle number of the instruction execution cycle of the execution unit to a low-power consumption cycle number.

10. The method of claim 9, wherein after the cycle number of the instruction execution cycle of the execution unit is adjusted to the low-power consumption cycle number, the control unit outputs the voltage adjustment instruction to cause the voltage control unit decreasing the supplied voltage to a low-power consumption supplied voltage.
